(19) United States
(12) Patent Application Publication
(10) Pub. No.: US 2022/0270269 A1
(43) Pub. Date: Aug. 25, 2022

(54) OBJECT THROUGHPUT USING TRAINED MACHINE LEARNING MODELS

(71) Applicant: Apeel Technology, Inc., Goleta, CA (US)

(72) Inventors: Richard Pattison, Goleta, CA (US); Pooyan Abouzar, Goleta, CA (US); Ohad Michel, Goleta, CA (US); Tim Rappold, Goleta, CA (US); Sahana Venkatesh, Goleta, CA (US); Saurabh Chatterjee, Goleta, CA (US)

(21) Appl. No.: 17/678,867

(22) Filed: Feb. 23, 2022

Related U.S. Application Data
(60) Provisional application No. 63/153,427, filed on Feb. 25, 2021.

(51) Int. Cl. G06T 7/246; G06T 7/292; G06V 10/764; G06V 10/82; G06T 7/60; G06V 10/774; G06V 20/68; G05B 19/4155

(52) U.S. Cl. CPC G06T 7/248; G06T 7/292; G06V 10/764; G06V 10/82; G06T 7/60; G06V 10/774; G06V 20/68; G05B 19/4155; G06T 2207/30242; G06T 2207/20084; G06T 2207/20081; G06T 2207/30128; G06V 2201/06; G05B 2219/45054; B07C 2501/009; B07C 5/342

(57) ABSTRACT

Disclosed are techniques for determining object throughput. A method may include obtaining first data representing a first image corresponding to a first time, identifying a first portion of the first data that depicts a first object at a first location, obtaining second data representing a second image corresponding to a second time, identifying a second portion of the second data that depicts the first object at a second location, obtaining third data indicating a counting threshold, determining based at least on the third data and the second location, that the first object satisfies the counting threshold, generating a value indicating a number of objects satisfying the counting threshold, the number of objects including the first object, generating a data value indicating a throughput of the number of objects based on the value indicating the number of objects satisfying the counting threshold and elapsed time between the first and second times.

### CROSS-REFERENCE TO RELATED APPLICATION

This application claims priority to U.S. Application No. 63/153,427, filed Feb. 25, 2021, the disclosure of which is incorporated herein by reference.

### BACKGROUND

Industrial food production and preparation sites involve data acquisition and processing. In some cases, data is acquired along a production line to inform subsequent processes including classification and sorting.

### SUMMARY

In addition to the embodiments of the attached claims and the embodiments described herein, the following numbered embodiments are also innovative.

Embodiment 1 is a method for identifying and tracking an object moving along a pathway, the method comprising: obtaining, by one or more computers from a first sensor, first data representing a first image captured at a first time of a first segment of the pathway; identifying, by the one or more computers and using an object detection model, a first portion of the first data that depicts a first object at a first location, the first object being at least one produce; obtaining, by the one or more computers from a second sensor, second data representing a second image captured at a second time subsequent the first time of a second segment of the pathway; identifying, by the one or more computers and using at least one classifier, a second portion of the second data that depicts the first object at a second location, wherein the second data is not processed using the object detection model; obtaining, by the one or more computers, third data indicating a counting threshold, the counting threshold representing a counting line along the pathway that is captured in at least one of the first data and the second data; determining, by the one or more computers, that the first object satisfies the counting threshold based at least in part on a quantity of the first object appearing in a predefined portion of the second data past the counting line; generating, by the one or more computers, a value indicating one or more objects that satisfy the counting threshold, wherein the one or more objects comprise the first object; and generating, by the one or more computers, a data value indicating a throughput by dividing the value indicating the one or more objects that satisfy the counting threshold by an elapsed time between the first time and the second time.

Embodiment 2 is the method of embodiment 1, wherein before determining that the first object satisfies the counting threshold, further comprising: determining, by the one or more computers, a comparative metric based at least on the first data and the second data; determining, by the one or more computers, whether the comparative metric satisfies a predetermined threshold; and updating, by the one or more computers, the data value indicating the throughput based on determining whether the comparative metric satisfies the predetermined threshold.

Embodiment 3 is the method of any one of embodiments 1 through 2, wherein the comparative metric includes a result of a calculation based on Intersection Over Union (IOU).

Embodiment 4 is the method of any one of embodiments 1 through 3, wherein determining that the first object satisfies the counting threshold comprises: determining that the first object does not satisfy the counting threshold based on identifying the first portion of the first data that depicts the first object at the first location; and determining that the first object satisfies the counting threshold based, at least in part, on determining that the first object does not satisfy the counting threshold based on identifying the first portion of the first data that depicts the first object at the first location.

Embodiment 5 is the method of any one of embodiments 1 through 4, wherein the at least one classifier is a convolutional neural network that was trained to (i) obtain one or more images as a tensor, (ii) identify first portions of the tensor corresponding to locations of other objects of a same produce type as the first object, and (iii) identify second portions of the tensor corresponding to areas of the one or more images that correspond to the first object.

Embodiment 6 is the method of any one of embodiments 1 through 5, further comprising: providing a feedback signal to a connected component in response to determining that the data value indicating the throughput of the one or more objects satisfies a predetermined condition.

Embodiment 7 is the method of any one of embodiments 1 through 6, wherein the predetermined condition specifies a required throughput value corresponding to the data value indicating the throughput of the one or more objects.

Embodiment 8 is the method of any one of embodiments 1 through 7, wherein the connected component is a control unit of a conveyor that conveys the one or more objects along the pathway, the data value is a size of the one or more objects, wherein the size of the one or more objects is determined, by the one or more computers, using the object detection model, and the feedback signal causes the control unit to adjust a velocity of the conveyor based on a weight per time rate satisfying a threshold weight per time rate for throughout along the pathway.

Embodiment 9 is the method of any one of embodiments 1 through 8, further comprising: obtaining, by the one or more computers, sensor data along the pathway where the one or more objects are located, and wherein the feedback signal is generated in response to the sensor data, the sensor data indicating a percentage decrease in maximum throughput for a process subsequent to moving the first object along the pathway.

Embodiment 10 is the method of any one of embodiments 1 through 9, wherein the connected component is an actuator of a conveyor that conveys the one or more objects, and wherein the feedback signal causes the actuator to actuate.

Embodiment 11 is the method of any one of embodiments 1 through 10, wherein the at least one classifier comprises a set of one or more Kernelized Correlation Filters (KCF).

Embodiment 12 is the method of any one of embodiments 1 through 11, wherein the first data includes at least a portion of the pathway where the one or more objects are located, the pathway being at least a conveyor in a facility.

Embodiment 13 is the method of any one of embodiments 1 through 12, wherein the one or more objects are one or more produce of a same type.

Embodiment 14 is the method of any one of embodiments 1 through 13, wherein the first and second sensors are at least one of hyperspectral sensors and visual cameras.

Embodiment 15 is the method of any one of embodiments 1 through 14, wherein the first sensor and the second sensor are the same sensor.

Embodiment 16 is the method of any one of embodiments 1 through 15, wherein the first sensor and the second sensor are different sensors.

Embodiment 17 is the method of any one of embodiments 1 through 14, wherein the object detection model was trained, using a training dataset of location information for other objects of a same produce type as the first object, to generate a prediction of a location and adjust parameters of the object detection model based on determining a difference between the prediction of the location and an actual location of the first object.

Embodiment 18 is the method of any one of embodiments 1 through 17, wherein identifying, by the one or more computers and using at least one classifier, a second portion of the second data that depicts the first object at a second location comprises comparing a first set of pixels representing the first object in the first data with at least one group of pixels in the second data until a threshold correlation value is determined, by the one or more computers, between the first set of pixels and the at least one group of pixels.

Embodiment 19 is the method of any one of embodiments 1 through 18, wherein the object detection model was trained using a training dataset to detect other objects in the training dataset and identify quality metrics for the other objects, wherein the other objects are a same produce type as the first object.

Embodiment 20 is a system for identifying and tracking an object moving through a pathway in a facility, the system comprising: a conveyor positioned in the facility and configured to route one or more produce to different locations in the facility; at least one camera positioned along at least one portion of the conveyor, the at least one camera configured to capture image data of the one or more produce as the one or more produce are routed to different locations in the facility by the conveyor; and a computer system configured to identify and track the one or more produce across the image data captured by the at least one camera, the computer system performing operations that include the method of any one of the embodiments 1 through 19.

Embodiment 21 is a system for identifying an object across multiple images as the object moves through a pathway in a facility, the system comprising: a conveyor system positioned in the facility and configured to route one or more objects between locations in the facility, wherein the one or more objects include produce; at least one camera positioned along at least one portion of the conveyor system, the at least one camera configured to capture time series of image frames of the at least one portion of the conveyor system as the one or more objects are routed between the locations in the facility by the conveyor system; and a computer system configured to identify and track the movement one or more objects across the image frames, the computer system performing operations that include: receiving information about the one or more objects being routed between the locations in the facility by the conveyor system, the information including at least (i) a first image frame captured, by the at least one camera, at a first time of the at least one portion of the conveyor system and (ii) a second image frame captured, by the at least one camera, at a second time of the at least one portion of the conveyor system, wherein the first image frame and the second image frame include a first object; identifying, using an object detection model, a first location of a bounding box representing the first object in the first image frame; identifying, using the object detection model, a second location of the bounding box representing the first object in the second image frame; determining a time that elapsed between the first image frame and the second image frame based on comparing the first location to the second location; determining a velocity and directionality of the first object based on the time that elapsed between the first image frame and the second image frame; determining a subsequent location of the bounding box representing the first object in a subsequent image frame based on the velocity and directionality of the first object; and returning the subsequent location of the bounding box representing the first object.

Embodiment 22 is the system of embodiment 21, wherein the computer system is further configured to perform operations comprising: receiving, from at the at least one camera, the subsequent image frame of the at least one portion of the conveyor system; and identifying the first object in the subsequent image frame based on applying the bounding box representing the first object to the subsequent image frame at the subsequent location.

Embodiment 23 is the system of any one of the embodiments 21 and 22, wherein the second time is a threshold amount of time after the first time.

Embodiment 24 is a system for determining throughput of objects moving through a pathway in a facility, the system comprising: a conveyor system positioned in the facility and configured to route one or more objects between locations in the facility, wherein the conveyor system includes bars that move the one or more objects along a pathway, the one or more objects including produce; at least one camera positioned along at least one portion of the conveyor system, the at least one camera configured to capture time series of image frames of the at least one portion of the conveyor system as the one or more objects are routed between the locations in the facility by the conveyor system; and a computer system configured to identify a throughput of the one or more objects on the conveyor system, the computer system performing operations that include: obtaining, from the at least one camera, first data representing a first image frame captured at a first time of the at least one portion of the conveyor system; determining, using an object detection model, a produce count indicating a quantity of objects that cross a counting line at the at least one portion of the conveyor system at a predetermined time interval, the produce count representing the quantity of objects per bar of the conveyor system at the at least one portion of the conveyor system; determining, based on the image data, pixel values on at least one color channel averaged over the pixels associated with the counting line at the at least one portion of the conveyor system; determining, based on a Fourier Transform of the mean pixel values, a frequency of the conveyor system, wherein the frequency of the conveyor system represents a frequency that the bars of the conveyor system pass the counting line at the at least one portion of the conveyor system, the frequency of the conveyor system being measured in bars per second; determining an object throughput on the conveyor system based on multiplying the produce count by the frequency of the conveyor system, the throughput being measured as a count of objects per second on the conveyor system; and returning the object throughput for the conveyor system.

Embodiment 25 is the system of embodiment 24, wherein the predetermined time interval is 2 seconds.

Embodiment 26 is the system of any of the embodiments 24 and 25, wherein the one or more objects are moving at a constant velocity on the conveyor system.

Embodiment 27 is the system of any of the embodiments 24 and 26, wherein the computer system is further configured to perform operations comprising: determining a second produce count indicating the number of objects that cross a second counting line at the at least one portion of the conveyor system, wherein the second counting line is positioned a threshold distance after the counting line at the at least one portion of the conveyor system; determining whether the produce count is within a threshold range from the second produce count; and returning the produce count based on a determination that the produce count is within the threshold range from the second produce count.

Embodiment 28 is the system of any of the embodiments 24 and 27, wherein the computer system is further configured to perform operations comprising: determining a second produce count indicating the number of objects that cross a second counting line at the at least one portion of the conveyor system, wherein the second counting line is positioned a threshold distance before the counting line at the at least one portion of the conveyor system; determining whether the produce count is within a threshold range from the second produce count; and returning the produce count based on a determination that the produce count is within the threshold range from the second produce count.

Embodiment 29 is the system of any of the embodiments 24 and 28, wherein the computer system is further configured to perform operations comprising: determining a second produce count indicating the number of objects that cross a second counting line at the at least one portion of the conveyor system, wherein the second counting line is positioned a threshold distance after the counting line at the at least one portion of the conveyor system; determining a third produce count indicating the number of objects that cross a third counting line at the at least one portion of the conveyor system, wherein the third counting line is positioned a threshold distance before the counting line at the at least one portion of the conveyor system; determining whether the produce count is within a threshold range from the second produce count and the third produce count; and returning the produce count based on a determination that the produce count is within the threshold range from the second produce count and the third produce count.

According to one innovative aspect of the present disclosure, a method for generating a throughput is disclosed. In one aspect, the method can include obtaining, by one or more computers, first data representing a first image corresponding to a first time; identifying, by the one or more computers, a first portion of the first data that depicts a first object at a first location; obtaining, by the one or more computers, second data representing a second image corresponding to a second time; identifying, by the one or more computers, a second portion of the second data that depicts the first object at a second location; obtaining, by the one or more computers, third data indicating a counting threshold; determining, by the one or more computers, based at least on the third data and the second location, that the first object satisfies the counting threshold; generating, by the one or more computers, a value indicating a one or more objects that satisfy the counting threshold, where the one or more objects include the first object; and generating, by the one or more computers, a data value indicating a throughput based on the value indicating the one or more objects that satisfy the counting threshold and elapsed time corresponding to the first time and the second time.

Other versions include corresponding systems, apparatus, and computer programs to perform the actions of methods defined by instructions encoded on computer readable storage devices.

These and other versions may optionally include one or more of the following features. For instance, in some implementations, before determining that the first object satisfies the counting threshold, the method further includes determining, by the one or more computers, a comparative metric based at least on the first data and the second data; determining, by the one or more computers, whether the comparative metric satisfies a predetermined threshold; and updating, by the one or more computers, the data value indicating the throughput based on determining whether the comparative metric satisfies the predetermined threshold.

In some implementations, the comparative metric includes a result of a calculation based on Intersection Over Union (IOU).

In some implementations, determining that the first object satisfies the counting threshold includes determining that the first object does not satisfy the counting threshold based on identifying the first portion of the first data that depicts the first object at the first location; and determining that the first object satisfies the counting threshold based, in part, on determining that the first object does not satisfy the counting threshold based on identifying the first portion of the first data that depicts the first object at the first location.

In some implementations, identifying, by the one or more computers, the first portion of the first data that depicts the first object at the first location includes providing the first data to an object detection model trained to detect the first object.

In some implementations, the object detection model is a convolutional neural network.

In some implementations, the method further includes providing a feedback signal to a connected component in response to determining that the data value indicating the throughput of the one or more objects satisfies a predetermined condition.

In some implementations, the predetermined condition specifies a required throughput value corresponding to the data value indicating the throughput of the one or more objects.

In some implementations, the connected component is a control unit of a conveyor that is conveying the one or more objects, and the feedback signal is configured to adjust the velocity of the conveyor.

In some implementations, the method further includes obtaining sensor data of a facility where the one or more objects are located, and where the feedback signal is generated in response to the sensor data.

In some implementations, the connected component is an actuator of a conveyor that is conveying the one or more objects, and the feedback signal is configured to actuate the actuator.

In some implementations, identifying the second portion of the second data that depicts the first object at the second location includes using a trained classifier to identify the second portion of the second data.

In some implementations, the trained classifier includes a set of one or more Kernelized Correlation Filters (KCF).

In some implementations, the first data includes at least a portion of an environment where the one or more objects are located.

In some implementations, the one or more objects are one or more food items.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for generating throughput using trained machine learning models.

FIG. 2 is a diagram showing an example of object detection and tracking using trained machine learning models.

FIG. 3 is a flow diagram illustrating an example of a process for generating throughput using trained machine learning models.

FIG. 4 is a diagram of computer system components that can be used to implement a system for generating throughput using trained machine learning models.

Like reference numbers and designations in the various drawings indicate like elements.

### DETAILED DESCRIPTION

The present disclosure is directed towards methods, systems, and computer programs for generating object throughput determinations using one or more trained machine learning models. In some implementations, an object detection system can be used to detect objects along a production line of a processing or production facility. The object detection system can be trained to detect a particular object relevant to the facility such as a particular type of produce for a production line that processes that particular type of produce. The trained object detection system can provide input into a second trained model of a tracking engine that tracks the movement of the objects along the production line by associating objects in a previous image with objects in a subsequent image. In some implementations, the tracking engine obtains an initial image that includes a first representation of target data and generates, based on training samples, a classifier. The classifier can be used to detect a second representation of the target data in any subsequently obtained image.

Knowing the throughput and size distribution of objects for a production line in a given facility is important for a number of reasons, including quality control and real-time production line management. For example, in a facility that processes different types of produce, one or more production lines can convey hundreds to hundreds of thousands or more individual produce items every hour. Currently, upstream indicators may be used to determine a given throughput of the system such as a number of objects shipped to the location to be processed. However, such upstream indicators do not allow for real-time feedback along a given production line. In some cases, it may be advantageous to monitor the throughput in one or more specific locations within a processing or production environment. Furthermore, such monitoring should be performed in-line with minimal interference.

The present disclosure is directed towards a machine learning based system to monitor objects being conveyed within a production or processing environment by automatically detecting, categorizing, and aggregating raw data of the objects within the environment. For example, as described in further detail below, environments, where objects are conveyed between processing or production stages, can be monitored by overhead cameras that provide the raw data to one or more computers configured to perform operations, including object detection, optical flow processing, kernelized correlation filters, or a combination thereof. Compared to manual monitoring techniques, such a system that employs the techniques of the present disclosure can handle more throughput, provide faster and more accurate results, provide results in real-time to automated actuators along the production line, provide results for analysis, all without damaging or otherwise interfering with the conveyance of objects thereby providing optimal throughput.

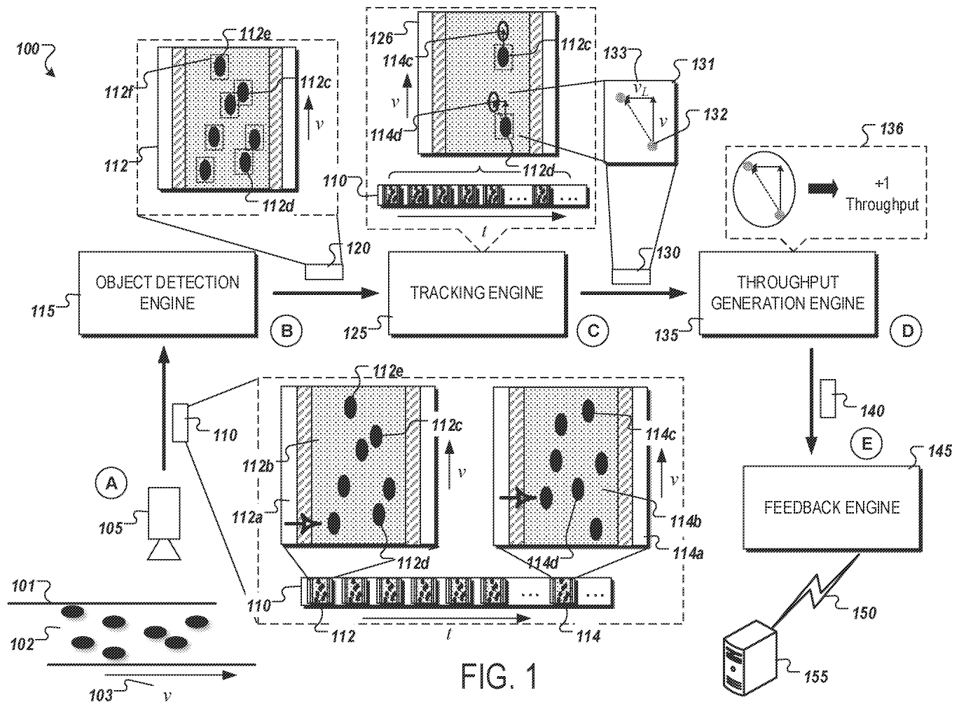

FIG. 1 is a diagram showing an example of a system 100 for generating throughput using trained machine learning models. The system 100 includes a conveyor 101 that conveys objects 102, a sensor 105 that obtains image data 110 of the objects 102, an object detection engine 115 that obtains the image data 110 and generates object detection data 120, a tracking engine 125 that obtains the object detection data 120 and generates tracking data 130, a throughput generation engine 135 that obtains the tracking data 130 and generates throughput data 140, and a feedback engine 145 that obtains the throughput data 140 and sends a signal 150 to a connected device 155. The feedback engine 145 is configured to provide feedback based on, at least, the throughput data 140. For purposes of the present disclosure, an “engine” is intended to mean one or more software modules, one or more hardware modules, or a combination of both, that, when used to process input data, cause one or more computers to realize the functionality attributed to the “engine” by the present disclosure.

In stage A of FIG. 1, the sensor 105 obtains the image data 110 of the objects 102 on the conveyor 101 that transports the objects 102 at a velocity 103. In general, the sensor 105 can be any sensor with an ability to capture representations of the objects 102. In some implementations, the sensor 105 includes a hyperspectral sensor configured to capture hyperspectral data of the objects 102. In some implementations, the sensor 105 is a visual camera configured to obtain images of the objects 102 on the conveyor 101. In the example of FIG. 1, the sensor 105 is positioned above the conveyor 101.

In some implementations, the sensor 105 can include multiple sensors. In such implementations, each sensor of the multiple sensors can be positioned at a different angle relative to one or more objects of the objects 102. For example, the sensor 105 can include a first camera and at least one additional camera that each capture images of the objects 102. The additional camera can obtain images that represent light waves detected by the additional camera that are of a different wavelength than the light waves detected by the first camera. In general, any wavelength or set of wavelengths can be captured by the sensor 105. Furthermore, the additional camera can be positioned at a different height or pointing angle compared to a first camera. The additional camera can be used, at least in part, to capture images of portions of objects that may be obscured from a view of the first camera.

The image data 110 includes at least a first image 112 and a second image 114. The first image 112 is captured at a first time and the second image 114 is captured at a second time that is subsequent to the first time. The first image 112 includes an environment portion 112a that represents a portion of the first image 112 that does not represent the objects 102 but rather an environment of a production or processing facility at which the conveyor 101 is located. The first image 112 also includes a conveyor portion 112b that represents the conveyor 101. Within the conveyor portion 112b, the first image 112 includes a representation of the objects 102 including a first object 112c, a second object 112d, and a third object 112e.

The first image 112 is captured at a first time (e.g., t1) and the second image 114 is captured at a second time (e.g., t2) that is subsequent to the first time. The second image 114, similar to the first image 112, includes an environment portion 114a that represents a portion of the second image 114 that does not represent the objects 102 but rather an environment of a production or processing facility at which the conveyor 101 is located. In some cases, the environment portion 114a is similar to the environment portion 112a. The second image 114 also includes a conveyor portion 114b that represents the conveyor 101. Within the conveyor portion 114b, the second image 114 includes a representation of the objects 102 including a first object 114c and a second object 114d.

The first object 112c, the second object 112d, and the third object 112e each correspond to a distinct object of the objects 102 and collectively represent a depiction of the location of these objects at time t1. The first object 114c of image 114 corresponds to the same first object 112c, with the first object 114c representing the location of the first object 112c at time t2. The second object 114d of image 114 corresponds to the same second object 112d, with the second object 114d representing the location of the second object 112d at time t2. Thus, in image 114 the object 114c is the same object as object 112c and the object 114d is the same object as object 112d, with the image 114 representing the location of the objects at a different point in time than the location of the objects in image 112. The second image 114 does not depict an object at time t2 that corresponds to the third object 112e at t1 due to the motion of the conveyor 101 and the objects 102. That is, at the time t2 when the second image 114 was captured, the third object 112e has already been moved beyond the field of view of the image sensor 105 by, for example, the movement of the conveyor 101, movement of the third object 112e, or the like.

Between a time t1 when the first image 112 was captured and a time t2 when the second image 114 was captured, the conveyor 101 can move in the direction indicated by the velocity 103. The second image 114 can depict a translated representation of one or more of the objects shown in the first image 112. The translation of the one or more objects from time t1 to time t2 can occur in any direction. By way of example, while some objects, such as the object corresponding to the first object 112c, 114c, do not have any perpendicular motion vectors or antiparallel motion vectors, other objects, such as the second object 112d, 114d do have at least a perpendicular motion vector or antiparallel motion vector component that represents any motion perpendicular or antiparallel to the motion of the conveyor 101 represented by the velocity 103.

In stage B of FIG. 1, the image data 110 is obtained by the object detection engine 115. In some implementations, each image of the image data 110 is sent individually to the object detection engine 115. For example, the sensor 105 can provide the first image 112 to the object detection engine 115 at one time and can provide the second image 114 to the object detection engine 115 at a subsequent time. Any intermediary or subsequent images can be provided to the object detection engine 115 in the order in which they were captured by the sensor 105. In some implementations, the sensor 105 groups one or more images together to be sent to the object detection engine 115. For example, it may be advantageous to reduce individual data transfers and the sensor 105 can group one or more adjacent images and then send the adjacent images to the object detection engine 115. Images provided to the object detection engine 115 can include data that represents a time when a given image was captured by the sensor 105 such that the object detection engine 115 or a subsequent process can determine the order of images obtained from the sensor 105.

The object detection engine 115 can process images by detecting regions of images included in the image data 110. For example, the object detection engine 115 can detect a region of pixels as corresponding to a known appearance of a given object for which the object detection engine 115 is trained to detect. The object detection engine 115 can similarly detect other portions of images that do not include any data corresponding to known appearances of the given object, such as background or portions of images that depict an environment in which one or more of the objects 102 is located.

The object detection engine 115 can be trained to detect one or more specific types of objects. In some implementations, the object detection engine 115 is trained to determine characteristics of objects in addition to detecting the objects within one or more images. For example, the object detection engine 115 can be trained to determine a quality metric for a given object represented in an image. Components of the quality metric can vary depending on the given object. For example, in the case of avocados, a quality metric can include ripeness, desiccation levels, or other relevant parameters programmable by a user or automated process. Quality determinations by a trained model such as the object detection engine 115 can be the result of a feedback process where known samples are used to train the model to recognize certain known characteristics of the known samples.

The object detection engine 115 can be trained using training samples that depict objects similar to the objects 102. The training samples can be labeled to include location information of the objects such that the object detection engine 115 can generate a prediction of a location and use the difference between the predicted location and the known location to adjust internal parameters of an underlying model of the object detection engine 115. By adjusting the internal parameters of the underlying model, the object detection engine 115 is able to increase the accuracy of object detections.

In some implementations, the object detection engine 115 can be trained in a production or processing environment. For example, the object detection engine 115 can obtain one or more images, such as the one or more images of the image data 110 and detect objects within the one or more images. An automated or manual process, such as a second trained model or user, can then be used to determine, based on known detection information including relative location information, the accuracy of the object detection engine 115. For example, the accuracy of the object detection engine 115 can be a function of the object detections generated by the object detection engine 115 compared to known ground truths. A difference between a prediction generated by the object detection engine 115 and a ground truth can be represented by a numerical value such as a displacement vector.

In some implementations, the difference between the prediction generated by the object detection engine 115 and the ground truth includes a normalized representation of the difference. For example, the prediction generated by the object detection engine 115 can be expressed as one or more coordinates in a coordinate system. The ground truth can similarly be expressed as one or more coordinates in the coordinate system. The difference can then be generated based on a normalized difference between the one or more coordinates representing the prediction and the one or more coordinates representing the ground truth. For example, a difference vector representing the difference between the one or more coordinates representing the prediction and the one or more coordinates representing the ground truth can include at least a first component representing the difference in a first dimension of two or more dimensions and a second component representing the difference in a second dimension of the two or more dimensions. The difference can be represented by a length corresponding to the difference vector.

In some implementations, an evaluation is conducted based on one or more predictions generated by the object detection engine 115. For example, metrics such as Intersection Over Union (IOU) can be generated based on a first area of the coordinate system that indicates a prediction generated by the object detection engine 115 and a second area of the coordinate system that indicates a ground truth. The area of overlap between the first area and the second area divided by the combined area of the first area and the second area can be used as the IOU for an evaluation result. An IOU closer to one can be associated with optimal performance while an IOU less than one can be associated with non-optimal performance. In some implementations, a predetermined IOU threshold can be used to determine if the object detection engine 115 is performing sufficiently well. For example, if the IOU threshold is below a threshold of 0.60, a user or an automated process of the system 100 can adjust the object detection engine 115, transfer the processes of the object detection engine 115 or another processing unit, or halt processing of images until adjustments can be made.

In some implementations, evaluation results can be provided to a user. For example, the evaluation result that includes the value of one or more IOU based values can be included in analysis data that is sent from the system 100 to be displayed on a user device. The system 100 can send a signal to the user device that is configured to display a dashboard that includes at least one evaluation result for the user. The user device can also provide interactive controls such that a user of the user device can instruct the system 100 to perform one or more actions in response to the at least one evaluation result.

In some implementations, evaluation results are used to further train the object detection engine 115. For example, evaluation results can include an IOU based value. In some cases, if the IOU based value is below a predetermined threshold, the object detection engine 115 can be further trained using training samples until at least one evaluation result includes an IOU based value that is above the predetermined threshold. Similarly, the average of a plurality of IOU based values can be generated and the average of the plurality of IOU based values can be compared with a predetermined threshold to determine if the object detection engine 115 requires further training. In this way, training can be performed as required instead of all at once which can reduce initial training time and processing requirements and also help the object detection engine 115 adapt to varying objects or situations over time.

The aforementioned implementations are described use of thresholding in a manner that requires a determination of whether a value is above or exceeds a predetermined threshold. However, such implementations are exemplary and are not intended to limit the scope of the present disclosure. In other implementations, for example, the implementations described above can also be implemented by determining whether a value falls below or does not exceed a predetermined threshold. In such implementations, the parameter value and comparator can be negated and achieve the same functionality by determining whether the parameter value falls below or does not exceed the predetermined threshold. Accordingly, determinations can be made as to whether a parameter value such as an IOU satisfies a predetermined threshold without requiring that such satisfaction is greater than or less than the threshold, which can ultimately be a design choice.

In some implementations, object detections generated by the object detection engine 115 include confidence values. For example, numerical values generated by the object detection engine 115 can be used to indicate a probability that a given object detection generated by the object detection engine 115 is accurate. The confidence values can be included with object detections generated by the object detection engine 115 or can be included in a separate data item generated by the object detection engine 115.

The object detection engine 115 can generate the object detection data 120 that includes object detections for objects included in the first image 112. As discussed herein, the object detection engine 115 can input the first image 112 into an object detection model of the object detection engine 115 in order to detect one or more objects represented in the first image 112. The object detection engine 115 can similarly generate object detections for other images including the second image 114.

In the example of FIG. 1, the object detection engine 115 can generate bounding boxes for the objects in the first image 112. In general, any method for indicating a position of an object within an image can be used by the object detection engine 115 as part of generating the object detections. For example, the object detection engine 115 can use center of mass points or other numerical values to indicate a given position within the image 112 corresponding to a position of an object.

The object detection engine 115 can detect multiple objects in the first image 112 including the first object 112c, the second object 112d, and the third object 112e. The object detection engine 115 bounds each of the multiple objects with a box that indicates the boundary of the multiple objects. As shown in FIG. 1, the object detection engine 115 generates a bounding box 112f that circumscribes the third object 112e.

In some implementations, the bounding boxes generated by the object detection engine 115 are used to determine a size of the one or more objects. For example, a size of one or more objects can be generated by the object detection engine 115 and inform subsequent processes as to a number of specifically sized objects as a component of a throughput measurement.

In some implementations, it may be advantageous to automatically adjust the throughput of the conveyor 101 in response to detecting one or more objects of a specific size. For example, in cases where a subsequent process in a production or processing environment relies on a specific mass of objects or functions at a specific rate, the system 100 can determine that a certain number of objects of a specific size corresponding to a total weight are moving towards the subsequent process. In order to prevent the subsequent process from either having too much product or too little product, the system 100 can adjust the velocity 103 of the conveyor 101 or actuate an actuator to divert or include one or more objects based on detecting one or more objects of a specific size and determining a corresponding weight per time rate is either more or less than a required weight per time rate. The weight per time rate can be a function of the computed throughput, the detected size or shape, or a determined weight based on one or more known relations between a given size and a given weight.

In some implementations, upstream processes can be adjusted based on one or more processes of the system 100. For example, a process that adds one or more objects to the conveyor 101 can be adjusted to add more or less objects or objects of a different origin to the conveyor 101. If the system 100 detects that the conveyor 101 is currently carrying a first amount of objects per unit of time and the first amount does not satisfy a predetermined threshold, the system 100 can send a signal configured to adjust an upstream process to adjust the amount of objects added to the conveyor 101 based on the difference between the first amount and the predetermined threshold. If the system 100 detects that the conveyor 101 is currently carrying a first amount of objects that do not satisfy size or quality metrics, the system 100 can send a signal configured to adjust an upstream process to adjust the origin of the objects added to the conveyor 101. For example, if an upstream system is currently obtaining objects from a first container, in response to obtaining the signal from the system 100, the upstream system can obtain objects from a second container that includes objects of a different size or quality.

In some implementations, the tracking engine 125 obtains one or more object detections from the object detection engine 115 and one or more images without object detections. For example, the tracking engine 125 can obtain images without the images being processed by the object detection engine 115. The tracking engine 125 can use the unprocessed images together with the object detections of a subset of images to generate the tracking data 130. In this way, the system 100 can conserve processing resources by limiting the amount of object detections and, instead, use the tracking engine 125 to track the movement of the objects 102 in the image data 110.

The object detection engine 115, depending on implementation, can be set to run periodically with the tracking engine 125 processing one or more images between the images processed by the object detection engine 115 in order to track the motion of the objects 102 over time. In some implementations, the object detection engine 115 processes a particular number of frames corresponding to a current velocity of the conveyor 101. For example, a current velocity of the conveyor 101 corresponding to the velocity 103 can be 5 inches per second and, based on the current velocity, the object detection engine 115 can perform object detection on every 30th frame in a 30 frame set. One or more of the 29 remaining frames in the 30 frame set can be processed by the tracking engine 125 before the object detection engine 115 processes a subsequent frame. In general, any rate of detection by the object detection engine 115 or processing by the tracking engine 125 can be used.

Similarly, depending on the current velocity of the conveyor 101, the frame rate of the sensor 105 can automatically adjust to capture more or fewer images. In some implementations, the sensor 105 or other processors can adjust the frame rate of the sensor 105 to capture a certain number of images of a given object as it moves through a region captured by the sensor 105. For example, a first number of images of an object can be required to establish accurate tracking of the given object within a given span of time or span of distance. The frame rate of the sensor 105 can adjust based on a current velocity of the conveyor 101 to capture the first number of images.

In some implementations, one or more operations of the system 100 are performed by machine learning models. For example, the object detection engine 115 can be performed by two machine learning models. First, a convolutional neural network, or other machine learning model, can locate the objects 102. Then, a second model can be used to determine the size or quality of the objects 102. The second model can use detection output of the first model in order to determine the size or quality of the objects 102. The second model can be trained to determine quality and size of an object based on a given location and representation of the object within one or more images. Similarly, the second model can determine the size of the object and/or a size distribution of objects in the one or more images, for example, based on (i) determining a hypotenuse of each object within its respective bounding box from the one or more images (e.g., detection output from the first model) and then (ii) determining a distribution of hypotenuses over some predetermined amount of time. Therefore, not only can the second model be used to determine the size of the object, the second model can also be used to determine the size distribution of objects that have been treated (e.g., coated in a shelf life extension coating solution) over the predetermined amount of time.

In some implementations, the machine learning models of the system 100 are separately trained to perform specific operations. For example, a first model that detects the objects 102 can be trained specifically to locate one or more objects within an input image based on the input image that includes one or more representations of the one or more objects. The first model for object detection can be separately trained and used within the object detection engine 115.

In some implementations, the machine learning models of the system 100 are collaboratively trained to perform specific operations. For example, a first model that detects the objects 102 can be trained collaboratively with a second model that, based on the first model detections, determines a size or quality of each of the detected objects. The second model can be trained using input from the first model.

In stage C of FIG. 1, the tracking engine 125 can obtain the object detection data 120. The object detection data 120 can include the object detections generated by the object detection engine 115 corresponding to the first image 112. The tracking engine 125 can also obtain the second image 114. The second image 114 is not processed by the object detection engine 115 thus reducing computational costs. The tracking engine 125 updates one or more bounding boxes from the object detection data 120 of the first image 112 based on locations of one or more corresponding objects in the second image 114. The tracking engine 125 uses a classifier based on the portion of the first image 112 corresponding to a given object and finds a portion of the second image 114 corresponding to the same given object based on the classifier. In this way, the tracking engine 125 can update the bounding box of the given object and effectively track the given object through multiple images.

For example, the tracking engine 125 can obtain the object detection data 120 including a bounding box corresponding to the second object 112d. The tracking engine 125 can generate a classifier corresponding to an appearance of the second object 112d in the first image 112. The tracking engine 125 can use the learned classifier to find a portion of the second image 114 corresponding to an appearance of the second object 114d. The tracking engine 125 can obtain a location of the portion of the second image 114 and updates the location of the bounding box corresponding to the second object 112d based on the location of the portion of the second image 114 identified by the learned classifier. The tracking engine 125 can continue tracking the second object 112d through multiple images.

In some implementations, the object detection engine 115 is rerun after the tracking engine 125 processes one or more subsequent images. In order to ensure that there is no double counting, an element of the system 100, such as the object detection engine 115 or the tracking engine 125, can generate an IOU based value. The IOU based value can be generated based on a first portion of a first image corresponding to a first object detection and a second portion of a second image corresponding to a second object detection. In order to ensure that the first object detection and the second object detection do not correspond to the same object, the overlap of the first portion and the second portion can be computed. The overlap can be divided by the combination of the first portion and the second portion to generate an IOU based value. If the IOU based value satisfies a predetermined threshold, the element of the system 100 can determine that the first object detection and the second object detection correspond to the same object and that at least one of the second object detection or the first object detection should be discarded. Similarly, if the IOU based value does not satisfy the predetermined threshold, the element of the system 100 can determine that the first object detection and the second object detection do not correspond to the same object and no detection need be discarded.

In some implementations, if a second location is determined based on a detection engine after a first location is determined based on a tracking engine, the first location corresponding to the tracking engine may be discarded. For example, the tracking engine 125 can determine a location of the second object 112d after a detection of the second object 112d by the object detection engine 115. At a later time, the object detection engine 115 can determine a subsequent location of the second object 112d. An element of the system 100, such as the object detection engine 115 or the tracking engine 125, can generate an IOU based value that compares the subsequent detection of the second object 112d to the tracked location of the second object 112d. If the IOU based value satisfies a determined threshold (e.g., the IOU based value is above or below a predetermined IOU threshold), the tracked location of the second object 112d can be discarded and replaced by the subsequent detection of the second object 112d determined by the object detection engine 115. For example, the tracking engine 125 may inaccurately determine the location of the second object 112d. If the location determined by the tracking engine 125 is not discarded, it can, depending on implementation, result in double counting of the second object 112d. By replacing the inaccurate location determined by the tracking engine 125 with the subsequent location determined by the object detection engine 115, the system 100 can avoid double counting and improve the accuracy of object location determination.

The tracking engine 125 identifies at least a portion of the second object 112d corresponding to values of a first set of pixels 132 at a corresponding location as shown in item 131. The tracking engine 125 then uses the first set of pixels 132 and at least the second image 114 to determine what group of pixels in the second image 114 is most strongly correlated with the first set of pixels 132 corresponding to the second object 112d.

After the tracking engine 125 determines what group of pixels in the second image 114 is most strongly correlated with the first set of pixels 132 based on values associated with the first set of pixels 132, the tracking engine 125 can predict a location of the second object 112d based on the second image 114 and the first set of pixels 132. In the example of FIG. 1, the set of vectors describing the motion of the object corresponding to the second object 112d include the velocity 103 corresponding to the movement of the conveyor 101 and a lateral velocity 133 corresponding to the object rolling to one side of the conveyor as the result of some disturbance or interference in the production or processing environment. In general, any vector can be used to describe motion of an object and the vector can point in any direction corresponding to the determined location of a given object.

In some implementations, the tracking engine 125 uses determined motion vectors to predict the location of objects. For example, the tracking engine 125 can determine the set of vectors describing the motion of the first object 112c. The tracking engine 125 can determine that the motion of the first object 112c includes only the velocity 103 of the conveyor 101 as the first object 112c is not detected to have any lateral or other motion. The tracking engine 125 can similarly perform tracking operations for other objects of the objects 102 represented in the first image 112. Item 126 is a simplified version including only two instances of moving objects for the sake of clarity. In an actual scenario, the tracking engine 125 can compute any number of motion vectors for any number of objects represented in a given input image. The motion vectors generated by the tracking engine 125 can then be stored in the tracking data 130.

In some implementations, the tracking engine 125 uses a match filter to determine what group of pixels in the second image 114 is most strongly correlated with the first set of pixels 132. The tracking engine 125 can compare the first set of pixels 132 with groups of pixels in the second image 114 until a correlation value threshold is satisfied. For example, the tracking engine 125 can start at a corner of the second image 114 and compare the pixels in the corner of the second image 114 to the first set of pixels 132. The tracking engine 125 can then compare the first set of pixels 132 to one or more other sets of pixels in the second image 114.

In some implementations, the first set of pixels 132 is compared to sets of pixels in the second image 114 based on a location of the first set of pixels 132 in the first image 112. For example, a region in the vicinity of the location of the first set of pixels 132 can be used to search for a set of pixels that match the first set of pixels 132. In some cases, a region in the vicinity of the location of the first set of pixels 132 can be a region centered on the location of the first set of pixels 132 with a predetermined radius.

In some implementations, a region in the vicinity of the location of the first set of pixels 132 includes a region shifted based on an expected motion of objects. For example, the tracking engine 125 can determine, based on the velocity 103, that a given object appearing in the first image 112 will likely appear at a particular position corresponding to the velocity 103 in a subsequently obtained image, such as the second image 114. If the velocity 103 is 3 inches per second and the difference between a first timestamp corresponding to the first image 112 and a second timestamp corresponding to the second image 114 is 1 second, the tracking engine 125 can determine, at least based on the first timestamp, the second timestamp, the velocity 103, and the location of the first set of pixels 132, an expected position in the second image 114. The expected position can be 3 inches from the location of the first set of pixels 132 in the direction indicated by the velocity 103. A region to be searched for matching sets of pixels can include a region centered on the expected position. In this way, processing power can be reduced by searching only in areas likely to contain relevant portions of an item being tracked. Since processing power can be reduced using the disclosed techniques, various processing tasks can be performed more efficiently in parallel. For example, as described above, identifying each of the items in the obtained image(s) using object detection techniques can be parallelized with tracking each of those items and/or determining characteristics/features of each of those items. Similarly, processing time can be reduced by reducing the number of pixel comparisons in areas where matches are not likely.

As mentioned above, searching only in areas likely to contain relevant portions of the item being tracked can reduce processing power and also make it easier and faster to track the item and maximize throughput. A smaller region of the obtained image(s) can be selected and processed using the disclosed techniques. The region to be searched can be an estimation box (e.g., bounding box) for the item that moved, based on the known velocity 103, in the obtained image(s). For the item, each obtained image where the item is successfully tracked can provide information about the item's velocity through a field of view (e.g., a change in x and/or y positioning from a first image to a second image). This velocity can be used to predict/estimate a location of the item in the next frame, and thus a new positioning of the estimation box. As an illustrative example, a change in a successful estimation box match between a first and a second image can provide a velocity vector. This velocity vector can then be used to adjust a cropping location in a subsequent image (e.g., a third image). As a result, instead of the tracking engine 125 having to search within a local vicinity for a proper estimation box matching in the subsequent image, the tracking engine 125 may have a higher likelihood of a successful match using the disclosed techniques. Accordingly, a velocity estimate for cropping the subsequent image can be a sum of a velocity estimate of a current image (e.g., a crop translation) and a translation of a successful track within the crop of the current image.

As an illustrative example, the item can be an avocado moving at a constant velocity on a conveyor belt. The velocity can be an x and/or y velocity of the conveyor belt. Using object detection techniques described herein, the avocado can be identified by a bounding box in a first image. The bounding box can also be considered the estimation box. The first image can be cropped around the bounding box by some fraction of a width and height of the bounding box. Knowing the velocity of the conveyor belt, the bounding box (e.g., estimation box) can then be moved at the velocity of the conveyor belt to a new position in a second image. The new position can be an estimation of where the avocado will appear next when moving at the constant velocity. Accordingly, the second image can be cropped around the bounding box. The bounding box in the second image can then be processed using the disclosed techniques instead of processing the entire second image to identify the avocado from the first image.

The disclosed techniques can be used with various conveyor systems. Example conveyor systems include rolling translating conveyor systems having horizontal bars (e.g., rollers) that items (e.g., produce) roll over along a pathway, from one location to a next location. Example conveyor systems may also include conveyor systems having sheets or other flat surfaces that move the items along a pathway (e.g., flat belt conveyor system), from one location to the next location. Moreover, since the velocity 103 is used to track the items, the disclosed techniques can accurately track the items regardless of how the items may move along the pathway in either x or y directions and/or by rolling or transforming to different positions/angles.

In some implementations, and as described above, the velocity 103 can be constantly updated (e.g., based on calculated throughput and other factors described herein). Accordingly, the velocity 103 can be calculated over a predetermined amount of previous frames/obtained images to determine the current velocity of the conveyor belt. The current velocity can then be used with the techniques described herein to accurately track the items as they move and appear in multiple images.

In some implementations, the tracking engine 125 searches the entire second image 114 for matches to the first set of pixels 132. For example, the tracking engine 125 can determine that no matches are found in a region in the vicinity of the location of the first set of pixels 132. Based on determining that no matches are found in a region in the vicinity of the location of the first set of pixels 132. the tracking engine 125 can search other areas of the second image 114. In some cases, the tracking engine 125 can search with an increasing radius based on an initial search region so as to gradually increase the search region to include more sets of pixels.

In some implementations, the tracking engine 125 searches the entire second image 114 for matches to the first set of pixels 132. For example, the tracking engine can search across the second image 114 in multiple rows until each area of the second image 114 has been processed or a correlation value threshold has been satisfied, where a correlation value threshold can include a numerical value indicating a degree of similarity between the first set of pixels 132 and another set of pixels. Any other deterministic algorithms may be used to similarly search the entire second image for matches to the first set of pixels 132. In general, the tracking engine 125 can search in any predefined region, such as a region in the vicinity of the location of the first set of pixels 132, by iteratively comparing sets of pixels until a correlation value threshold has been satisfied or the tracking engine 125 determines that additional regions are to be searched based on the correlation value not satisfying a given threshold.

In some implementations, the tracking engine 125 uses adjacent images of the image data 110. For example, instead of processing the nonadjacent images including the first image 112 and the second image 114, the tracking engine 125 can process the first image 112 and an image adjacent to the first image 112. In general, any two or more images can be used by the tracking engine 125 to generate the tracking data 130.

In some implementations, the object detection data 120 includes multiple object detections from multiple images processed by the object detection engine 115. For example, the object detection engine 115 can obtain two or more images corresponding to images captured by the sensor 105. The object detection engine 115 can then generate object detections for each object within the two or more images. The object detection engine 115 can then provide the object detections for each object within the two or more images to the tracking engine 125.

In some implementations, the object detection data 120 includes object detections from a single image processed by the object detection engine 115. For example, the object detection engine 115 can obtain a single image such as the first image 112 and then generate object detections for each object within the single image. The object detection engine 115 can then provide the object detections corresponding to the single image to the tracking engine 125. The object detection engine 115 can provide subsequent object detections at a later time. The tracking engine 125 can then store object detections of two or more images in order to aid in the generation of the tracking data 130.

In some implementations, the tracking engine 125 is a neural network. For example, the tracking engine 125 can be a convolutional neural network including one or more fully connected layers. The tracking engine 125 can obtain one or more images of the image data 110 as a tensor. The tensor, depending on implementation, can include multiple dimensions such as number of images, image height, image width, or input channels where input channels can include the three colors red, green, and blue or other channels specified by a user or automated process. The tracking engine 125 can identify portions of the input tensor corresponding to locations of the objects corresponding to the first object 112c and the second object 112d. Similarly, the tracking engine 125 can identify portions of the input tensor corresponding to areas of the second image 114 that generate a high degree of similarity when compared with the identified portions corresponding to the first object 112c.

In some implementations, the tracking engine 125 is configured to perform sparse optical flow. For example, the tracking engine 125 can identify the first set of pixels 132 as the edge or a corner of the object corresponding to the second object 112d. It may be advantageous to implement the tracking engine 125 as a sparse optical flow system in order to reduce computational costs within a production or processing environment.

In some implementations, the tracking engine 125 is trained using real images of objects similar to the objects 102. For example, the tracking engine 125 can obtain a training data set that includes images of objects that are the same type of objects as objects 102. The tracking engine 125 can further be trained to obtain input from the object detection engine 115 in order to aid in optical flow generation. The training data set can include images of objects similar to the objects 102 over time as the objects move. Ground truth data corresponding to the actual movements of the objects can be used in order to train the tracking engine 125 to identify subsequent movements. For example, the tracking engine 125 can generate a prediction value corresponding to a determined location of an object in a subsequent image. By comparing the prediction to the ground truth value corresponding to the given training data set, the tracking engine 125 can be trained. In some cases, ground truth locations can be determined based on the object detection engine 115 or another object detection process.

In some implementations, the tracking engine 125 is trained to track one or more objects based on a predetermined algorithm. For example, the tracking engine 125 can be trained according to the specifics of a gradient-based algorithm, such as gradient descent, where parameters of a machine learning model corresponding to the tracking engine 125 are adjusted to reduce a prediction gap between a prediction generated by the tracking engine 125 and a corresponding ground truth.

In some implementations, the tracking engine 125 is trained using computer-generated images of objects that are similar to the objects 102. For example, in order to increase accuracy and decrease manual effort involved in training the tracking engine 125, a training data set for training the tracking engine 125 can include images of computer-generated objects similar to the objects 102. The images of the computer-generated objects can depict the computer-generated objects moving in a particular way. Because the objects, as well as their movements, are computer-generated, the precise location of the objects at any given point in time is known. Given this precise location data, the tracking engine 125 can be trained to track objects.

In some implementations, the tracking engine 125 is trained by shifting a first sample image and using the shift images as training data. For example, the tracking engine 125 can obtain a first sample image representing at least one object. The tracking engine 125 or another system configured to train the tracking engine 125 can shift the first image representing at least one object such that the first image is represented in the shifted image at a different location than the first image. The shift can move pixels that represent the object. The shift can move the pixels vertically, horizontally, or both vertically and horizontally. In some cases, multiple shifts can be performed to generate multiple shifted images to be used for training.

In some implementations, a first sample image is shifted cyclically. For example, a first sample image can be shifted vertically down by 30 pixels, vertically down by 15 pixels, vertically up by 15 pixels, and vertically up by 30 pixels. In general, any shift amount, either in pixel measurements or other measurements, can be used to shift an object of interest in the first sample image. Cyclic shifting can be used to generate shifted images of the first sample image that can be used to generate one or more Kernelized Correlation Filters (KCF) in order to inform tracking of one or more objects. In some cases, shifting aspects of the first sample image cyclically allow the system 100 to exploit redundancies in order to make training and detection of the tracking engine 125 more efficient.

In stage D of FIG. 1, the throughput generation engine 135 obtains the tracking data 130. The throughput generation engine 135 determines, based on the tracking data 130, a throughput value that indicates a number of objects per measure of time. The throughput generation engine 135 obtains the one or more motion vectors included in the tracking data 130 and determines, based on the tracking data 130, at least a number of objects. The throughput generation engine 135, using the tracking data 130, is able to accurately determine a number of objects without double counting or missing objects due to unexpected motion as the motion of all objects are captured with the motion vectors of the tracking data 130.

In some implementations, a defined threshold is used to determine a throughput value. For example, a user or an automated component of the system 100 can define a threshold as a line perpendicular to the motion of the conveyor 101 indicated by the velocity 103. The throughput generation engine 135 can determine, based on the tracking data 130 including locations of one or more objects of the objects 102 and a location of the defined threshold, how many of the objects 102 cross the defined threshold over a given time window and divide by the time corresponding to the time window. In this way, the throughput generation engine 135 can generate a throughput in terms of objects per unit of time.

In some implementations, the throughput generation engine 135 is a trained machine learning model. For example, the throughput generation engine 135 can be trained to receive motion vectors and determine, based on the motion vectors a number of objects moving at a particular velocity along a conveyor such as the conveyor 101. Depending on implementation, the throughput generation engine 135 can compute an average velocity of one or more objects moving in the direction of conveyance, such as a direction parallel with the velocity 103 and use the average velocity in the direction of conveyance and the number, size, or quality of each object to determine the throughput data 140.

As shown in item 136, the throughput generation engine 135 processes one or more tracked locations corresponding to the second object 112d. As discussed herein, the second object 112d moves laterally in a direction perpendicular to the direction of conveyance indicated by the direction of the velocity 103. The lateral motion is described herein as the lateral velocity 133 shown graphically in item 131 and 136.

In some implementations, the throughput generation engine 135 processes size or quality information. For example, the object detection engine 115 or another process can determine the size or quality of one or more objects included in the objects 102. Depending on the size or quality of the one or more objects, the throughput generation engine 135 can add a corresponding value representing the size or quality of the one or more objects to the throughput data 140. For example, if one or more objects included in the objects 102 are below an average size, the throughput generation engine 135 can include one or more values corresponding to the one or more objects indicating that the size of the one or more objects is below the average size. Similarly, if one or more objects included in the objects 102 are of bad quality, rotten, not sufficiently ripe, or in another condition in the case of produce or otherwise having some defect specified by the system 100, the throughput generation engine 135 can include one or more values to indicate object attributes such as quality, ripeness, rottenness, or other attributes applicable in the given object production or processing environment.

In some implementations, the throughput generation engine 135 adjusts a resultant throughput value based on determined attributes such as quality, size, and the like. For example, the throughput generation engine 135 can increase the throughput value if more objects of the objects 102 are determined to be above an average size. The throughput generation engine 135 or another element of the system 100 can make determinations of object attributes such as size and quality. Similarly, if one or more objects included in the objects 102 are of good quality or satisfy some specified quality criterion, either set by an automated process or by a user, the throughput generation engine 135 can adjust a resultant throughput value to reflect the number of good quality objects. The resultant throughput value can be adjusted based on one or more attributes of the objects 102 and be included in the throughput data 140.

In stage E of FIG. 1, the feedback engine 145 obtains the throughput data 140. The feedback engine 145 can use the throughput data 140 to perform a subsequent process. The feedback engine 145 sends the signal 150 to the connected device 155 to perform the subsequent process based on the throughput data 140. In some implementations, the subsequent process includes adjusting the velocity 103 of the conveyor 101. For example, the feedback engine 145 can send a signal to a control unit of the conveyor 101. The feedback engine 145 may determine that a throughput value included in the throughput data 140 satisfies a threshold. The feedback engine 145 can, in response to determining that the throughput value included in the throughput data 140 satisfies the threshold, send a signal to a control unit of the conveyor 101 to either increase or decrease the velocity 103 of the conveyor 101.

In some implementations, the subsequent process includes rerouting the objects 102 and the connected device 155 is an actuator along a production line conveying the objects 102. For example, the feedback engine 145 can send the signal 155 to a splitting actuator that, by actuating in response to obtaining the signal 155, separates a portion of the objects 102 into a separate stream of objects. The splitting actuator can be a motor attached to a flap that, by actuating, rotates across the conveyor 101 and creates a barrier such that the objects 102 are forced from a first path along the conveyor 101 to another path in a different direction from the direction of the conveyor 101. In general, any type of actuator capable of changing the direction of one or more objects can be used based on the signal 150 from the feedback engine 145.

In some implementations, the feedback engine 145 sends a representation of the throughput data 140 included in the signal 150 to the connected device 155. For example, the connected device 155 can be a user terminal or storage database that obtains the throughput data 140 based on receiving the signal 150. The signal 150 can be any kind of wired or wireless signal. The connected device 155 can display one or more items of the throughput data 140 to a user in a graphical user interface. The connected device 155 can also store the throughput data 140 or perform further analysis on the throughput data 140.

In some implementations, the feedback engine 145 sends the signal 150 in response to the throughput data 140 satisfying a condition. For example, a throughput value of the throughput data 140 may be above a specified value. The feedback engine 145 can then send the signal 150 that includes data corresponding to the throughput data 140 and an alert that specifies that the throughput value is above the specified value. The specified value may be determined by a user beforehand or by the system 101 based on one or more other sensor data of the environment that includes the conveyor 101 such as a production or processing facility.

In some implementations, the feedback engine 145 generates the signal 150 based on sensor data captured of an environment that includes the conveyor 101 such as a production or processing facility. For example, the feedback engine 145 can obtain sensor data that indicates malfunctioning of a process subsequent to the conveyor 101 in a processing or production environment. The sensor data can indicate a percentage decrease in maximum throughput for the process subsequent to the conveyor 101. Based on the sensor data and the throughput data 140, the feedback engine 145 can determine that the conveyor 101 is currently providing greater throughput than what the subsequent process can handle based on the sensor data. The feedback engine 145 can send the signal 150 to a control unit of the conveyor 101 to decrease the velocity 103 of the conveyor 101 in order to decrease the throughput of the conveyor 101 to a level that can be accommodated by the process subsequent to the conveyor 101.

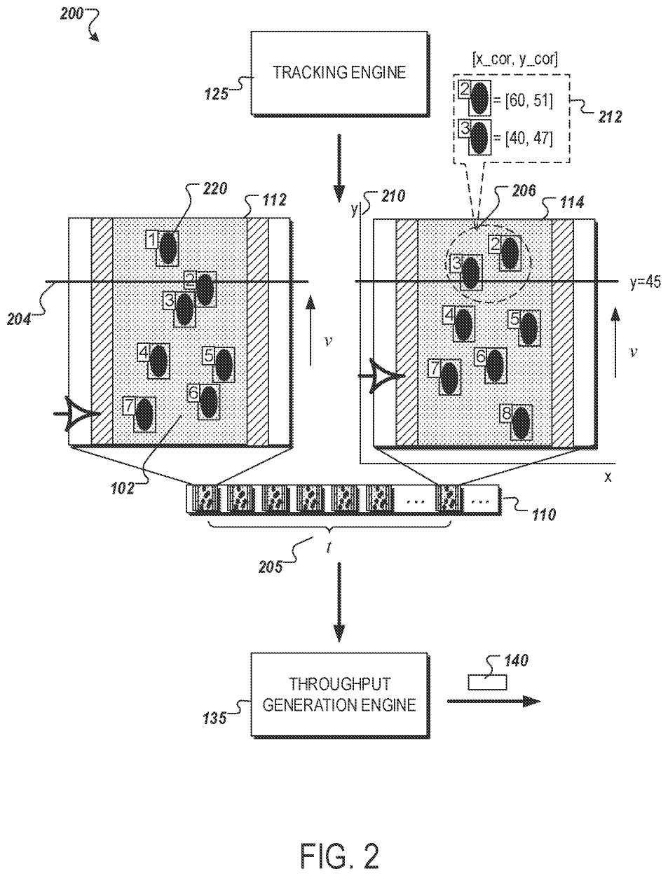

FIG. 2 is a diagram showing an example 200 of object detection, tracking, and throughput generation using trained machine learning models. The example 200 is based on the system 100 of FIG. 1.

The example 200 includes the tracking engine 125 providing data, such as the tracking data 130, to the throughput generation engine 135. The throughput generation engine 135 determines, based on the data provided by the tracking engine 125, a counting threshold, and a period of time, a throughput value corresponding to the number of objects crossing the counting threshold within that same period of time. In the example 200, the counting threshold is a counting line 204 and the period of time is a time period 205 corresponding to the time between a time corresponding to the capture of the first image 112 and a time corresponding to the capture of the second image 114.

Each item of the tracking data 130 can include unique identifiers corresponding to each object tracked by the tracking engine 125. For example, as shown in the example 200, each object of the objects 102 is displayed with a single number. The single number identifies each of the objects. In general, an identifier for an object can be any sort of key, which can be represented by symbols such as numbers or letters that uniquely identifies a given object of one or more objects.

The throughput generation engine 135 determines, based on the location of the counting line 204 and the location of the objects 206 that the objects 206 have crossed the counting line 204. In some implementations, an object is determined to have crossed a counting threshold based on a location of a particular part of the object. For example, the particular part of the object can be the geometric center of the object. When the center of the object is beyond the counting threshold, as measured by a given coordinate system, the given object is determined to have crossed the counting threshold.

The example 200 shows coordinates 212 for the objects 206. The coordinates 212 and the location of the counting line 204 is based on a coordinate system 210. In general, any applicable coordinate system can be used. The coordinates 212 both include a y coordinate that is greater than the y coordinate associated with the counting line 204. In the example 200, the y coordinate associated with the counting line 204 is 45 and y coordinates of the coordinates 212 for the objects 206 are, respectively, 51 and 47.

The throughput generation engine 135 determines, based on the locations of the objects 206, represented in this case by the coordinates 212, and the location of the counting line 204 that the objects 206 have crossed the counting line 204 and should be counted. To generate a throughput, the throughput generation engine 135 can divide the value associated with the number of objects that have crossed the counting line 204 by the time period 205. The resulting value can be included in the throughput data 140.

Moreover, the throughput generation engine 135 can generate the throughput based on multiplying a conveyor belt frequency (or a speed/velocity of the conveyor belt) by a quantity of objects that have been detected as crossing the counting line 204, as described above. The throughput can be generated whenever the objects 206 intersect the counting line 204. In some implementations, as described herein, the object detection techniques can be performed at predetermined time intervals (e.g., every 1, 2, 3, 4, 5, 6 seconds, etc.). The object detection techniques described herein can include counting a number of objects (e.g., bounding boxes) that cross and/or touch the counting line 204 at the predetermined time intervals, such as every 2 seconds. This count can provide an estimate of a number of the objects 206 per bar, assuming that the objects 206 are moving at a same speed/velocity as the bar(s) of the conveyor belt and those objects 206 are neither falling nor being counted on multiple bars of the conveyor belt. The count can be measured in objects per bar.

The count of objects per bar can be multiplied by a periodicity value (e.g., conveyor belt frequency mentioned above) to determine throughput, measured in objects per second. The periodicity value can be computed from a Fourier Transform of the pixel values on a single color channel (red, green, or blue) averaged across the width of the conveyor. After all, pixel intensity averaged over the counting line 204 parallel to a bar (e.g., roller, horizontal bar) of a conveyor belt should be periodic. The Fourier Transform can therefore be used to extract a dominant frequency signal from the mean pixel values. The dominant frequency signal can correlate to a frequency of the conveyor belt, as mentioned above, which can be measured in conveyor bars per second. In other words, the frequency of the conveyor belt can be an estimated frequency of bars of the conveyor belt passing the counting line 204, measured in bars per second.

The techniques described herein can be beneficial to accurately, efficiently, and quickly count the objects 206, regardless of whether and how the objects 206 change their positions in x and/or y directions (e.g., the objects 206 can roll and translate) as they are moved along the conveyor belt (e.g., such as on the bars of rolling translating conveyor systems). Accurately counting the objects 206 can result in accurate and quick determinations of throughput by the throughput generation engine 135.

As shown in FIG. 2, one counting line 204 can be used to perform the techniques described herein. In some implementations, one or more additional counting lines can be used to audit results from the counting line 204 (e.g., to determine whether a quantity of the objects 206 intersecting and crossing the counting line 204 is accurate or within some expected threshold range). For example, a second counting line can be positioned after the counting line 204. A third counting line can be positioned before the counting line 204. The tracking engine 125, for example, can determine a first object count indicating a number of the objects 206 that cross the counting line 204 at a predetermined time interval. The tracking engine 125 can also determine a second object count indicating a number of the objects 206 that cross the second counting line at the predetermined time interval. Moreover, the tracking engine 125 can determine a third object count indicating a number of the objects 206 that cross the third counting line at the predetermined time interval. The tracking engine 125 can then compare the first, second, and third object counts to determine whether the first object count is within some threshold range of the second and/or third object counts. If the first object count is within the threshold range, then the tracking engine 125 can determine that the first object count is likely accurate. If, on the other hand, the first object count is not within the threshold range of the second and/or third object counts, then the tracking engine 125 may determine that the first object count is inaccurate and object detection techniques described herein should be refined and/or the objects 206 should be recounted. One or more additional or fewer counting lines can be used with the disclosed techniques.

In the example 200, the first image 112 includes object 220 but the second image 114 does not include the object 220. In some implementations, the tracking engine 125 uses a failure count to determine when an object has left a field of view. For example, the tracking engine 125 tracks the object 220 in the first image 112. The tracking engine 125 may track the object 220 in subsequent images. In some cases, tracking the object 220 in subsequent images includes finding the object 220 by using a trained classifier to find pixel sets similar to pixel sets corresponding to the object 220. If the tracking engine 125 cannot find the object 220 in a given subsequent image, the tracking engine 125 can increment a failure count corresponding to the object 220. If the failure count satisfies a threshold, the tracking engine 125 can determine that the object 220 is no longer in the field of view.

For example, the failure count threshold can be 5. If the tracking engine 125 cannot find the object 220 in at least 5 images and the failure count is incremented to a value of 5, the tracking engine 125 can determine that the object 220 is no longer in the field of view. In some cases, if the tracking engine 125 finds the object 220 in a given image, the failure count can be reset to accommodate for instances in which an object may be obscured from view or otherwise non-visible. In some implementations, the tracking engine 125 and the throughput engine 135 exchange object related data. For example, the throughput engine 135 can send data corresponding to which objects crossed the counting line 204. The tracking engine 125 can obtain the object related data and determine that tracking no longer needs to be performed for the objects that have already crossed the counting line 204. In this way, the tracking engine 125 need not further track objects that have already been counted and included in the throughput calculation performed by the throughput engine 135.

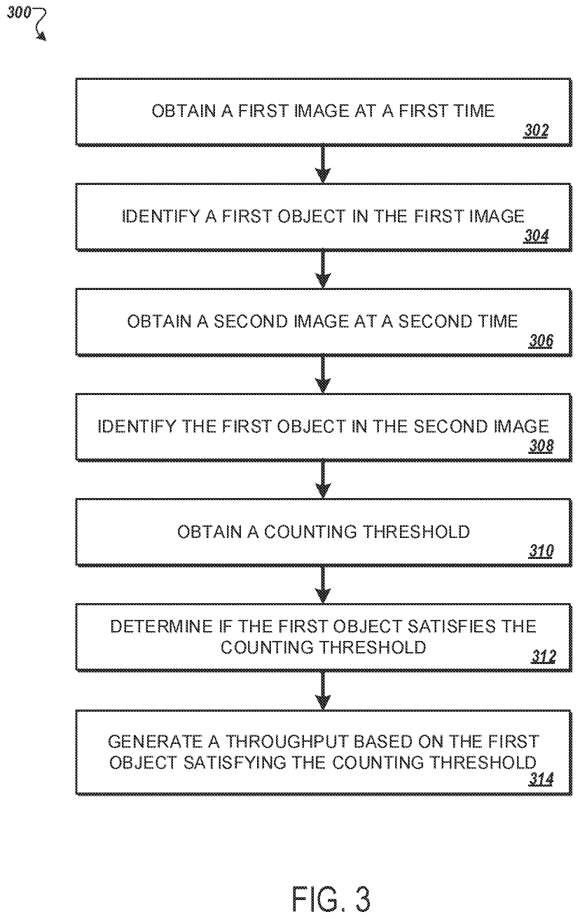

FIG. 3 is a flow diagram illustrating an example of a process 300 for generating throughput using trained machine learning models. The process 300 can be performed by one or more systems or devices such as the system 100 of FIG. 1.

The process 300 includes obtaining a first image at a first time (302). For example, the sensor 105 of FIG. 1 can obtain the image data 110 of the objects 102. The image data 110 can include the first image 112 captured at time t1.

The process 300 includes identifying a first object in the first image (304). For example, the object detection engine 115 can include a trained network that is trained to detect objects of one or more types. The object detection engine 115 can be trained to detect objects of a type corresponding to the first object and identify the first object in the first image based on obtaining the first image as input data.

The process 300 includes obtaining a second image at a second time (306). For example, the sensor 105 of FIG. 1 can obtain the image data 110 of the objects 102. The image data 110 can include the second image 112 captured at time t2.

The process 300 includes identifying the first object in the second image (308). For example, the tracking engine 125 can use a trained classifier to track the first object from the first image captured at time t1 through one or more images to the second image 112 captured at time t2. The tracking engine 125 can identify one or more sets of pixels in the second image that are similar to one or more sets of pixels in the first image that correspond to the first object. Based on the similarity, as determined by the trained classifier, the tracking engine 125 can determine a new location for the first object as it moves from time t1 to time t2.

The process 300 includes obtaining a counting threshold (310). For example, a user can determine a counting line, such as the counting line 204 shown in FIG. 2, over which objects are counted as contributing to a throughput value. The counting line can be a virtual line corresponding to an actual location, such as a location along the conveyor 101.

The process 300 includes determining if the first object satisfies the counting threshold (312). For example, the throughput generation engine 135 can determine, based on the location of the counting line 204 and the location of the objects 206 that the objects 206 have crossed the counting line 204.

The process 300 includes generating a throughput based on the first object satisfying the counting threshold (314). For example, to generate a throughput, the throughput generation engine 135 can divide the value associated with the number of objects that have crossed the counting line 204 by the time period 205 where the time period 205 represents the time between a first time when the objects 206 were not over the counting line 204 and a second time when the objects 206 were over the counting line 204.

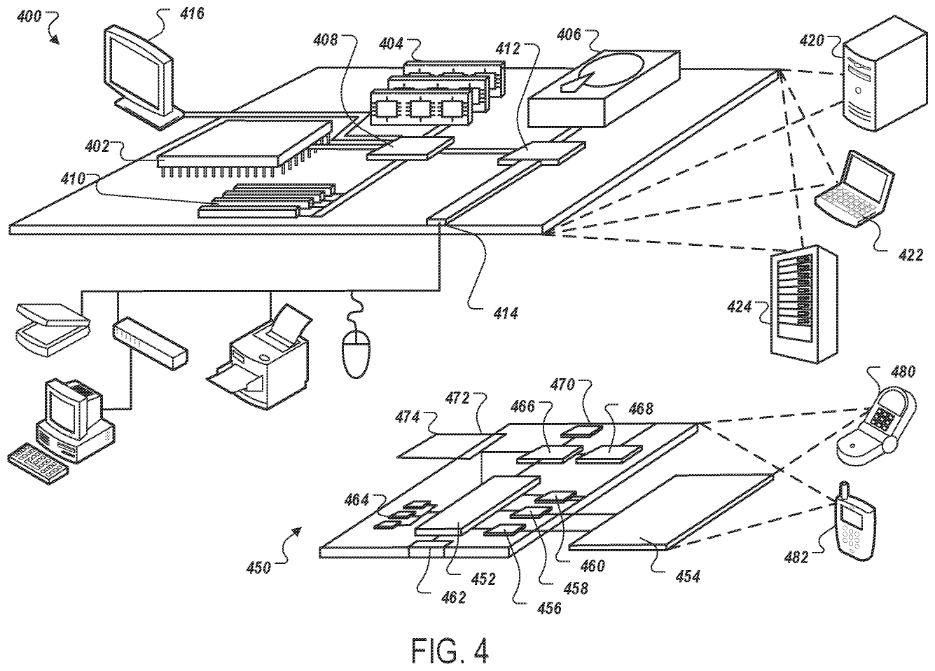

FIG. 4 is a diagram of computer system components that can be used to implement a system for generating throughput using trained machine learning models. The computing system includes computing device 400 and a mobile computing device 450 that can be used to implement the techniques described herein. For example, one or more components of the system 100 could be an example of the computing device 400 or the mobile computing device 450.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method for identifying and tracking an object moving along a pathway, the method comprising:
obtaining, by one or more computers from a first sensor, first data representing a first image captured at a first time of a first segment of the pathway;
identifying, by the one or more computers and using an object detection model, a first portion of the first data that depicts a first object at a first location, the first object being at least one produce;
obtaining, by the one or more computers from a second sensor, second data representing a second image captured at a second time subsequent the first time of a second segment of the pathway;
identifying, by the one or more computers and using at least one classifier, a second portion of the second data that depicts the first object at a second location, wherein the second data is not processed using the object detection model;
obtaining, by the one or more computers, third data indicating a counting threshold, the counting threshold representing a counting line along the pathway that is captured in at least one of the first data and the second data;
determining, by the one or more computers, that the first object satisfies the counting threshold based at least in part on a quantity of the first object appearing in a predefined portion of the second data past the counting line;
generating, by the one or more computers, a value indicating one or more objects that satisfy the counting threshold, wherein the one or more objects comprise the first object; and
generating, by the one or more computers, a data value indicating a throughput by dividing the value indicating the one or more objects that satisfy the counting threshold by an elapsed time between the first time and the second time.

2. The method of claim 1, before determining that the first object satisfies the counting threshold, further comprising:
determining, by the one or more computers, a comparative metric based at least on the first data and the second data;
determining, by the one or more computers, whether the comparative metric satisfies a predetermined threshold; and
updating, by the one or more computers, the data value indicating the throughput based on determining whether the comparative metric satisfies the predetermined threshold.

3. The method of claim 2, wherein the comparative metric includes a result of a calculation based on Intersection Over Union (IOU).

4. The method of claim 1, wherein determining that the first object satisfies the counting threshold comprises:
determining that the first object does not satisfy the counting threshold based on identifying the first portion of the first data that depicts the first object at the first location; and
determining that the first object satisfies the counting threshold based, at least in part, on determining that the first object does not satisfy the counting threshold based on identifying the first portion of the first data that depicts the first object at the first location.

5. The method of claim 1, wherein the at least one classifier is a convolutional neural network that was trained to (i) obtain one or more images as a tensor, (ii) identify first portions of the tensor corresponding to locations of other objects of a same produce type as the first object, and (iii) identify second portions of the tensor corresponding to areas of the one or more images that correspond to the first object.

6. The method of claim 1, further comprising:
providing a feedback signal to a connected component in response to determining that the data value indicating the throughput of the one or more objects satisfies a predetermined condition.

7. The method of claim 6, wherein the predetermined condition specifies a required throughput value corresponding to the data value indicating the throughput of the one or more objects.

8. The method of claim 6, wherein the connected component is a control unit of a conveyor that conveys the one or more objects along the pathway,
the data value is a size of the one or more objects, wherein the size of the one or more objects is determined, by the one or more computers, using the object detection model, and
the feedback signal causes the control unit to adjust a velocity of the conveyor based on a weight per time rate satisfying a threshold weight per time rate for throughout along the pathway.

9. The method of claim 8, further comprising:
obtaining, by the one or more computers, sensor data along the pathway where the one or more objects are located, and wherein the feedback signal is generated in response to the sensor data, the sensor data indicating a percentage decrease in maximum throughput for a process subsequent to moving the first object along the pathway.

10. The method of claim 6, wherein the connected component is an actuator of a conveyor that conveys the one or more objects, and wherein the feedback signal causes the actuator to actuate.

11. The method of claim 1, wherein the at least one classifier comprises a set of one or more Kernelized Correlation Filters (KCF).

12. The method of claim 1, wherein the first data includes at least a portion of the pathway where the one or more objects are located, the pathway being at least a conveyor in a facility.

13. The method of claim 1, wherein the one or more objects are one or more produce of a same type.

14. The method of claim 1, wherein the first and second sensors are at least one of hyperspectral sensors and visual cameras.

15. The method of claim 1, wherein the first sensor and the second sensor are the same sensor.

16. The method of claim 1, wherein the first sensor and the second sensor are different sensors.

17. The method of claim 1, wherein the object detection model was trained, using a training dataset of location information for other objects of a same produce type as the first object, to generate a prediction of a location and adjust parameters of the object detection model based on determining a difference between the prediction of the location and an actual location of the first object.

18. The method of claim 1, wherein identifying, by the one or more computers and using at least one classifier, a second portion of the second data that depicts the first object at a second location comprises comparing a first set of pixels representing the first object in the first data with at least one group of pixels in the second data until a threshold correlation value is determined, by the one or more computers, between the first set of pixels and the at least one group of pixels.

19. The method of claim 1, wherein the object detection model was trained using a training dataset to detect other objects in the training dataset and identify quality metrics for the other objects, wherein the other objects are a same produce type as the first object.

20. A system for identifying and tracking an object moving through a pathway in a facility, the system comprising:
a conveyor positioned in the facility and configured to route one or more produce to different locations in the facility;
at least one camera positioned along at least one portion of the conveyor, the at least one camera configured to capture image data of the one or more produce as the one or more produce are routed to different locations in the facility by the conveyor; and
a computer system configured to identify and track the one or more produce across the image data captured by the at least one camera, the computer system performing operations that include:
obtaining, from a first sensor, first data representing a first image captured at a first time of a first segment of the pathway;
identifying, using an object detection model, a first portion of the first data that depicts a first object at a first location, the first object being at least one produce;
obtaining, from a second sensor, second data representing a second image captured at a second time subsequent the first time of a second segment of the pathway;
identifying, using at least one classifier, a second portion of the second data that depicts the first object at a second location, wherein the second data is not processed using the object detection model;
obtaining third data indicating a counting threshold, the counting threshold representing a counting line along the pathway that is captured in at least one of the first data and the second data;
determining that the first object satisfies the counting threshold based at least in part on a quantity of the first object appearing in a predefined portion of the second data past the counting line;
generating a value indicating one or more objects that satisfy the counting threshold, wherein the one or more objects comprise the first object; and
generating a data value indicating a throughput by dividing the value indicating the one or more objects that satisfy the counting threshold by an elapsed time between the first time and the second time.

21. A system for identifying an object across multiple images as the object moves through a pathway in a facility, the system comprising:
a conveyor system positioned in the facility and configured to route one or more objects between locations in the facility, wherein the one or more objects include produce;
at least one camera positioned along at least one portion of the conveyor system, the at least one camera configured to capture time series of image frames of the at least one portion of the conveyor system as the one or more objects are routed between the locations in the facility by the conveyor system; and
a computer system configured to identify and track the movement one or more objects across the image frames, the computer system performing operations that include:
receiving information about the one or more objects being routed between the locations in the facility by the conveyor system, the information including at least (i) a first image frame captured, by the at least one camera, at a first time of the at least one portion of the conveyor system and (ii) a second image frame captured, by the at least one camera, at a second time of the at least one portion of the conveyor system, wherein the first image frame and the second image frame include a first object;
identifying, using an object detection model, a first location of a bounding box representing the first object in the first image frame;
identifying, using the object detection model, a second location of the bounding box representing the first object in the second image frame;
determining a time that elapsed between the first image frame and the second image frame based on comparing the first location to the second location;
determining a velocity and directionality of the first object based on the time that elapsed between the first image frame and the second image frame;
determining a subsequent location of the bounding box representing the first object in a subsequent image frame based on the velocity and directionality of the first object; and
returning the subsequent location of the bounding box representing the first object.

22. The system of claim 21, wherein the computer system is further configured to perform operations comprising:
receiving, from at the at least one camera, the subsequent image frame of the at least one portion of the conveyor system; and
identifying the first object in the subsequent image frame based on applying the bounding box representing the first object to the subsequent image frame at the subsequent location.

23. The system of claim 21, wherein the second time is a threshold amount of time after the first time.

24. A system for determining throughput of objects moving through a pathway in a facility, the system comprising:
a conveyor system positioned in the facility and configured to route one or more objects between locations in the facility, wherein the conveyor system includes bars that move the one or more objects along a pathway, the one or more objects including produce;
at least one camera positioned along at least one portion of the conveyor system, the at least one camera configured to capture time series of image frames of the at least one portion of the conveyor system as the one or more objects are routed between the locations in the facility by the conveyor system; and
a computer system configured to identify a throughput of the one or more objects on the conveyor system, the computer system performing operations that include:
obtaining, from the at least one camera, first data representing a first image frame captured at a first time of the at least one portion of the conveyor system;
determining, using an object detection model, a produce count indicating a quantity of objects that cross a counting line at the at least one portion of the conveyor system at a predetermined time interval, the produce count representing the quantity of objects per bar of the conveyor system at the at least one portion of the conveyor system;
determining, based on the image data, pixel values on at least one color channel averaged over the pixels associated with the counting line at the at least one portion of the conveyor system;
determining, based on a Fourier Transform of the mean pixel values, a frequency of the conveyor system, wherein the frequency of the conveyor system represents a frequency that the bars of the conveyor system pass the counting line at the at least one portion of the conveyor system, the frequency of the conveyor system being measured in bars per second;
determining an object throughput on the conveyor system based on multiplying the produce count by the frequency of the conveyor system, the throughput being measured as a count of objects per second on the conveyor system; and
returning the object throughput for the conveyor system.

25. The system of claim 24, wherein the predetermined time interval is 2 seconds.

26. The system of claim 24, wherein the one or more objects are moving at a constant velocity on the conveyor system.

27. The system of claim 24, wherein the computer system is further configured to perform operations comprising:
determining a second produce count indicating the number of objects that cross a second counting line at the at least one portion of the conveyor system, wherein the second counting line is positioned a threshold distance after the counting line at the at least one portion of the conveyor system;
determining whether the produce count is within a threshold range from the second produce count; and
returning the produce count based on a determination that the produce count is within the threshold range from the second produce count.

28. The system of claim 24, wherein the computer system is further configured to perform operations comprising:
determining a second produce count indicating the number of objects that cross a second counting line at the at least one portion of the conveyor system, wherein the second counting line is positioned a threshold distance before the counting line at the at least one portion of the conveyor system;
determining whether the produce count is within a threshold range from the second produce count; and
returning the produce count based on a determination that the produce count is within the threshold range from the second produce count.

29. The system of claim 24, wherein the computer system is further configured to perform operations comprising:
determining a second produce count indicating the number of objects that cross a second counting line at the at least one portion of the conveyor system, wherein the second counting line is positioned a threshold distance after the counting line at the at least one portion of the conveyor system;
determining a third produce count indicating the number of objects that cross a third counting line at the at least one portion of the conveyor system, wherein the third counting line is positioned a threshold distance before the counting line at the at least one portion of the conveyor system;
determining whether the produce count is within a threshold range from the second produce count and the third produce count; and
returning the produce count based on a determination that the produce count is within the threshold range from the second produce count and the third produce count.
